(19) United States
(12) Patent Application Publication
(10) Pub. No.: US 2025/0146838 A1
(43) Pub. Date: May 8, 2025

(54) METHOD AND SYSTEM FOR DOWNLOADING A LATEST MAP

(71) Applicant: HYUNDAI AUTOEVER CORP., Seoul (KR)

(72) Inventor: Jong Gon Kim, Seoul (KR)

(73) Assignee: HYUNDAI AUTOEVER CORP., Seoul (KR)

(21) Appl. No.: 18/940,506

(22) Filed: Nov. 7, 2024

(30) Foreign Application Priority Data
Nov. 8, 2023 (KR) 10-2023-0153764

(51) Int. Cl. G01C 21/00; H04W 4/46; H04W 4/80

(52) U.S. Cl. CPC G01C 21/387; G01C 21/3841; H04W 4/46; H04W 4/80

(57) ABSTRACT

A method for downloading latest map data and being performed by a navigation device of a vehicle includes receiving a scheduled driving route stored in a local storage within each of a plurality of adjacent vehicles from each of the plurality of adjacent vehicles. The plurality of adjacent vehicles is adjacent to the vehicle having the navigation device. The method also includes obtaining identical path matching percentage information about each of the plurality of adjacent vehicles based on the scheduled driving route. The method also includes receiving the latest map data stored in the local storage within an adjacent vehicle having the identical path matching percentage exceeding a first reference value. The method also includes providing a benefit to the adjacent vehicle that transmits the latest map data.

### CROSS-REFERENCE TO RELATED APPLICATION

This application claims the benefit of and priority to Korean Patent Application No. 10-2023-0153764 filed on Nov. 8, 2023 in the Korean Intellectual Property Office, the entire contents of which are incorporated herein by reference.

### TECHNICAL FIELD

The present disclosure relates to a method and a system for downloading latest map data and, more specifically, relates to a method and a system for downloading the latest map data using Vehicle to Vehicle (V2V) technology.

### BACKGROUND

Vehicle to Vehicle (V2V) technology is a communication network technology in which vehicles may exchange information about speeds, positions, etc., thereof with each other in real time through wireless communication. The V2V technology has the purpose of promoting safe driving of drivers through communication with surrounding vehicles.

In one example, the V2V technology may allow each vehicle to detect and notify a blind spot on behalf of surrounding vehicles or to recognize surrounding situations in a faster manner using various functions such as lane change assistance and forward collision prevention.

Thus, the V2V technology is growing rapidly. However, there is still an inconvenience in that the latest map data should be updated from a server in order to update map data on a navigation device.

Online download scheme as one of the schemes for downloading the map data from a navigation system has the advantage of being able to receive road information or traffic conditions in real time. However, the online download scheme incurs an excessive communication fee due to increased data usage.

Therefore, in order to achieve the above problem, it is required to provide a method for downloading the map data using the V2V technology in order to solve the problem of the excessive communication fee.

The subject matter described in this background section is intended to promote an understanding of the background of the disclosure and thus may include subject matter that is not already known to those of ordinary skill in the art.

### SUMMARY

The present disclosure aims to provide a method and a system for downloading the latest map that may download map data using short-range communication technology.

The present disclosure also aims to provide a method and a system for downloading the latest map that may download the latest map data from adjacent vehicles using Vehicle to Vehicle (V2V) technology.

The technical purposes of the present disclosure are not limited to the technical purposes mentioned above, and other technical purposes not mentioned may be clearly understood by those having ordinary skill in the art from descriptions as set forth below.

According to an embodiment of the present disclosure, a method for downloading latest map data and being performed by a navigation device of a vehicle may include receiving a scheduled driving route stored in a local storage within each of a plurality of adjacent vehicles from each of the plurality of adjacent vehicles. The plurality of adjacent vehicles is adjacent to the vehicle having the navigation device. The method may also include obtaining identical path matching percentage information about each of the plurality of adjacent vehicles based on the scheduled driving route. The method may also include receiving the latest map data stored in the local storage within an adjacent vehicle having the identical path matching percentage exceeding a first reference value. The method may also include providing a benefit to an adjacent vehicle that transmits the latest map data.

In an embodiment, the plurality of adjacent vehicles may include a plurality of adjacent vehicles configured to be connected to the vehicle having the navigation device via short-range communication.

In an embodiment, receiving the scheduled driving route from each of the plurality of adjacent vehicles may include connecting to each of the plurality of adjacent vehicles via short-range communication. Receiving the scheduled driving route from each of the plurality of adjacent vehicles may also include receiving the scheduled driving route based on a final destination of each of the plurality of adjacent vehicles connected to the vehicle via the short-range communication. The final destination of each of the plurality of adjacent vehicles is close to a final destination of the vehicle having the navigation device.

In an embodiment, obtaining the identical path matching percentage information about each of the plurality of adjacent vehicles may include segmenting the scheduled driving route received from each of the plurality of adjacent vehicles into a plurality of short distance routes. Obtaining the identical path matching percentage information about each of the plurality of adjacent vehicles may also include determining whether each of the scheduled driving route of each of the plurality of adjacent vehicles is identical with a scheduled driving route of the vehicle having the navigation device, based on the plurality of short distance routes. Obtaining the identical path matching percentage information about each of the plurality of adjacent vehicles may include obtaining the identical path matching percentage information of each of the plurality of adjacent vehicles, based on a determination result.

In an embodiment, lengths of the plurality of short distance routes obtained by segmenting the scheduled driving route may be equal to each other.

In an embodiment, the method may also include obtaining the plurality of short distance routes by segmenting the scheduled driving route based on spacings between adjacent traffic signals arranged in the scheduled driving route.

In an embodiment, determining whether each of the scheduled driving route of each of the plurality of adjacent vehicles is identical with the scheduled driving route of the vehicle having the navigation device, based on the plurality of short distance routes may include determining whether each of the short distance routes of the scheduled driving route of each of the plurality of adjacent vehicles is identical with each of segmented short distance routes of the scheduled driving route of the vehicle having the navigation device.

In an embodiment, determining whether each of the scheduled driving route of each of the plurality of adjacent vehicles is identical with the scheduled driving route of the vehicle having the navigation device, based on the plurality of short distance routes may include determining whether each of the segmented short distance routes of the scheduled driving route of each of the plurality of adjacent vehicles is identical with each of short distance routes of the scheduled driving route of the vehicle having the navigation device. Obtaining the identical path matching percentage information of each of the plurality of adjacent vehicles, based on the determination result may include classifying each of the segmented short distance routes of the scheduled driving route of each of the plurality of adjacent vehicles into matching and non-matching short distance routes with the segmented short distance routes of the scheduled driving route of the vehicle having the navigation device. Obtaining the identical path matching percentage information of each of the plurality of adjacent vehicles, based on the determination result may also include calculating the identical path matching percentage information based on a percentage of the matching short distance routes among the plurality of segmented short distance routes.

In an embodiment, receiving the latest map data stored in the local storage within the adjacent vehicle having the identical path matching percentage exceeding the first reference value may include classifying the plurality of adjacent vehicles, based on the identical path matching percentage. Receiving the latest map data stored in the local storage within the adjacent vehicle having the identical path matching percentage exceeding the first reference value may also include selecting the adjacent vehicle having the identical path matching percentage exceeding the first reference value from among the classified plurality of adjacent vehicles. Receiving the latest map data stored in the local storage within the adjacent vehicle having the identical path matching percentage exceeding the first reference value may also include receiving the latest map data stored in the local storage in the selected adjacent vehicle from the selected adjacent vehicle.

In an embodiment, selecting the adjacent vehicle having the identical path matching percentage exceeding the first reference value from among the classified plurality of adjacent vehicles may include when there are a plurality of adjacent vehicles respectively having the identical path matching percentages exceeding the first reference value, selecting one adjacent vehicle from the plurality of adjacent vehicles respectively having the identical path matching percentages exceeding the first reference value.

In an embodiment, selecting the one adjacent vehicle may include selecting one adjacent vehicle having a highest identical path matching percentage among the plurality of adjacent vehicles having the identical path matching percentages exceeding the first reference value.

In an embodiment, selecting the one adjacent vehicle may include selecting one adjacent vehicle, based on a download time of the latest map data from each of the plurality of adjacent vehicles.

In an embodiment, providing the benefit to the adjacent vehicle that transmits the latest map data may include determining the benefit to be provided to the adjacent vehicle, based on a number of movement route changes of the adjacent vehicle that transmits the latest map data.

In an embodiment, the method may also include determining the number of movement route changes of the adjacent vehicle based on a number of times the vehicle receiving latest map data re-searches for the adjacent vehicle transmitting the latest map data.

In an embodiment, providing the benefit to the adjacent vehicle that transmits the latest map data may include determining a benefit to be provided to the adjacent vehicle, based on a capacity of the latest map data having been transmitted from the adjacent vehicle.

In an embodiment, the method may also include determining the capacity of the latest map data having been transmitted from the adjacent vehicle based on an amount of the latest map data having been received by the vehicle from the adjacent vehicle.

According to an embodiment of the present disclosure, a navigation device for transmitting latest map data may include a processor configured to transmit a scheduled driving route stored in a local storage of the navigation device to a navigation device of an adjacent vehicle. The adjacent vehicle is adjacent to a vehicle including the navigation device for transmitting the latest map data. The processor is also configured to receive a request of transmitting the latest map data based on the scheduled driving route from the navigation device of the adjacent vehicle. The processor is also configured to display real-time download information of the latest map data in response to receiving the request of transmitting the latest map data.

In an embodiment, the processor may further be configured to display an auxiliary UI indicating speed information of the vehicle including the navigation device for transmitting the latest map data.

According to an embodiment of the present disclosure, a navigation device for receiving latest map data may include a processor configured to receive a scheduled driving route from a navigation device included in each of a plurality of adjacent vehicles. The plurality of adjacent vehicles is adjacent to a vehicle including the navigation device for receiving the latest map data. The processor is also configured to determine identical path matching percentage information about each of the scheduled driving routes. The processor is also configured to display a download expected time information about each of the scheduled driving routes, based on each of the scheduled driving routes and the latest map data stored in each of the plurality of navigation devices.

In an embodiment, the processor may further be configured to select one of the received scheduled driving routes based on a user input; and display real-time download information of the selected scheduled driving route.

### BRIEF DESCRIPTION OF DRAWINGS

The above and other aspects and features of the present disclosure should become more apparent by describing in detail illustrative embodiments thereof with reference to the attached drawings, in which:

FIG. 1 is a configuration diagram of latest map data download system according to an embodiment of the present disclosure;

FIG. 2 is a flow chart showing a process of downloading the latest map data according to an embodiment of the present disclosure;

FIG. 3 is a detailed flowchart showing a process in which a navigation device acquires identical path matching percentage information based on a scheduled driving route;

FIG. 4 is a detailed flowchart showing a process in which a navigation device receives the latest map data;

FIG. 5 is a detailed flowchart showing a process in which a benefit is determined based on the number of movement route changes;

FIG. 6 is a detailed flowchart showing a process of determining a benefit based on transmitted capacity of the latest map data;

FIG. 7 is an example diagram showing information about adjacent vehicles displayed on a navigation device before receiving the latest map data;

FIG. 8 is an example of information about the adjacent vehicle being displayed on the navigation device during the process of receiving the latest map data;

FIG. 9 is an example diagram of a state in which download progress status information is displayed on a navigation device disposed in an adjacent vehicle transmitting the latest map data;

FIG. 10 is an example diagram showing benefit information generated based on a route keeping condition and a data reception condition;

FIG. 11 is an example of benefit information displayed on a navigation device transmitting the latest map data; and

FIG. 12 is an example hardware configuration diagram of a computing system 1000 according to an embodiment of the present disclosure.

### DETAILED DESCRIPTIONS

Hereinafter, embodiments of the present disclosure are described with reference to the attached drawings. Advantages and features of the present disclosure and methods of accomplishing the same may be understood more readily by reference to the following detailed description of embodiments and the accompanying drawings. The present disclosure may, however, be embodied in many different forms and should not be construed as being limited to the embodiments set forth herein. Rather, these embodiments are provided so that the present disclosure can be thorough and complete and can fully convey the concept of the disclosure to those having ordinary skill in the art, and the present disclosure should be defined by the appended claims.

In adding reference numerals to the components of each drawing, it should be noted that the same reference numerals are assigned to the same or equivalent components as much as possible even though the components are shown in different drawings. In addition, in describing the present disclosure, when it is determined that the detailed description of the related well-known configuration or function may obscure the gist of the present disclosure, the detailed description thereof has been omitted.

Unless otherwise defined, all terms used in the present disclosure (including technical and scientific terms) may be used in a sense that can be commonly understood by those having ordinary skill in the art. In addition, the terms defined in the commonly used dictionaries are not ideally or excessively interpreted unless the terms are specifically defined clearly. The terminology used herein is for the purpose of describing particular embodiments only and is not intended limit the present disclosure. In the present disclosure, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled”, or “contacted” to another component, the component may be directly connected to or contacted with the other component, or it should be understood that another component may also be “connected,” “coupled” or “contacted” between the two components. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

Hereinafter, embodiments of the present disclosure are described with reference to the drawings.

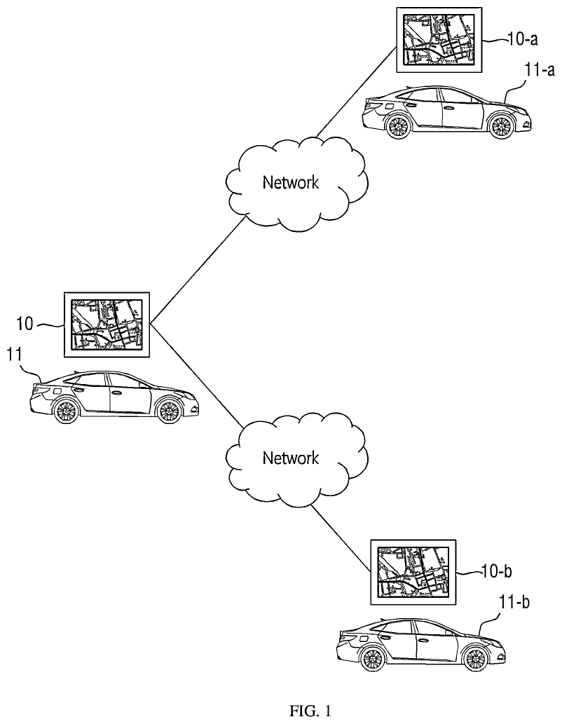

FIG. 1 is a configuration diagram of latest map data download system according to one embodiment of the present disclosure.

As shown in FIG. 1, the configuration of the latest map data download system may include navigation devices 10, 10-a, 10-b and adjacent vehicles 11, 11-a, 11-b. In this regard, the navigation devices 10, 10-a, 10-b may be respectively disposed in the adjacent vehicles 11 to 11-b. Each of the navigation devices 10, 10-a, 10-b may be equipped with a local storage in which a scheduled driving route and the latest map data of the scheduled driving route are stored.

Next, the navigation devices 10, 10-a, 10-b may be connected to each other via short-range communication, and in this regard, communication technologies such as WIFI and Bluetooth may be used as the short-range communication. However, the short-range communication technology is not limited thereto.

In this way, each of the navigation devices 10, 10-a, 10-b may download the latest map data through the navigation device included in the adjacent vehicle connected thereto via the short-range communication rather than through a server. Then, when the latest map data is downloaded using the navigation device of the adjacent vehicle, excessive communication fee may be prevented. The specific details related thereto are described in detail through the drawings below.

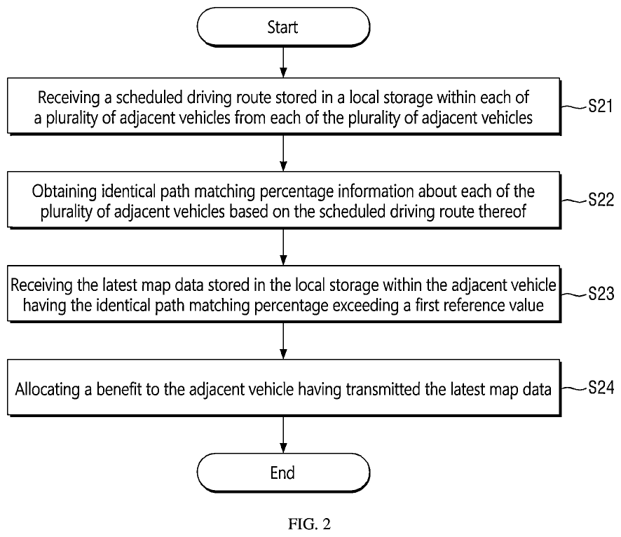

FIG. 2 is a flowchart showing a process of receiving the latest map data from the adjacent vehicle.

In step S21, the navigation device may receive a scheduled driving route from the navigation device of each of the plurality of adjacent vehicles. In this regard, the plurality of adjacent vehicles may include a plurality of adjacent vehicles that may be connected to each other via short-range communication.

Specifically, first, the navigation device may be connected to the navigation devices respectively equipped with the plurality of adjacent vehicles via short-range communication. In this regard, the navigation device may receive the scheduled driving route based on a final destination of each of the plurality of adjacent vehicles connected to each other via short-range communication. In this regard, the navigation device may receive only the scheduled driving route of each of those among the plurality of adjacent vehicles whose final destinations are close to each other.

This is because the continuous download process may be performed only when the latest map data is transmitted only from each of the vehicles having final destinations are close to each other among the plurality of adjacent vehicles.

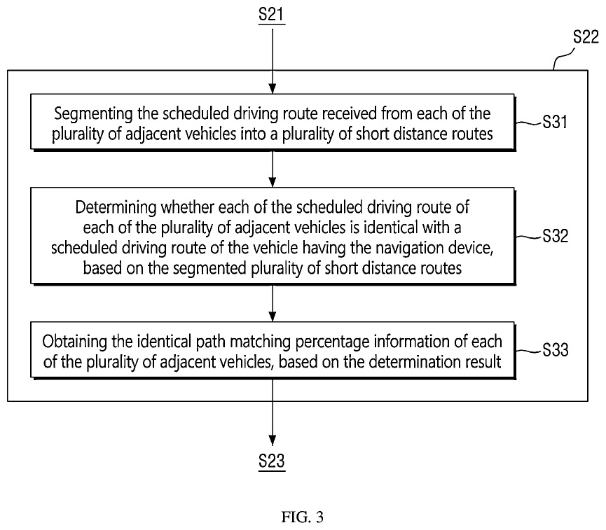

In step S22, the navigation device may obtain identical path matching percentage information based on the scheduled driving route received from the navigation device of the adjacent vehicle. In this regard, the identical path matching percentage information may be calculated as a numerical value obtained by comparing the respective scheduled driving routes of the navigation devices with each other. When the numerical value is high, it may be determined that the identity between the scheduled driving routes is high. The specific details related thereto are described in detail in FIG. 3 below.

In step S23, the navigation device may receive the latest map data stored in the local storage in the adjacent vehicle. The navigation device may select one adjacent vehicle based on the scheduled driving route of step S22. Accordingly, the navigation device may receive the latest map data stored in the local storage in the selected adjacent vehicle in step S23.

In step S24, a benefit may be provided to the adjacent vehicle equipped with the navigation device that transmits the latest map data. Specifically, when the vehicle having transmitted the latest map data maintains the route until the map data transmission has been completed, a predetermined point as the benefit may be provided to the vehicle having transmitted the latest map data.

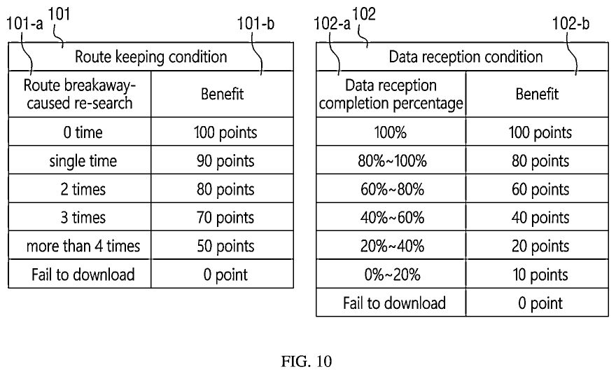

Next, the vehicle having received the benefit may use the point to pay for a fuel fee, etc. However, the benefit provided to the vehicle having transmitted the latest map data may vary based on a route keeping condition of the data transmitting vehicle and a data reception percentage of the data receiving vehicle. The specific details related thereto are described in detail in FIG. 10.

FIG. 3 is a detailed flowchart showing a process in which a navigation device acquires identical path matching percentage information based on a scheduled driving route.

In step S31, the navigation device may divide or segment the scheduled driving route received from the navigation device of the adjacent vehicle into a plurality of short distance routes. In this regard, the plurality of short distance routes may be generated by dividing or segmenting the scheduled driving route into portions of an equal distance. Alternatively, the plurality of short distance routes may be generated by dividing and segmenting the scheduled driving route based on a spacing between traffic signals included in the scheduled driving route. However, this is only an example, and a scheme of dividing or segmenting the scheduled driving route is not limited thereto.

In step S32, the navigation device may determine whether each of the scheduled driving routes of the plurality of adjacent vehicles is identical with the scheduled driving route of the vehicle including the navigation device. Specifically, the navigation device may determine whether each of the respective short distance routes as obtained in step S31 of the plurality of adjacent vehicles is identical with each of short distance routes of the scheduled driving route of the vehicle including the navigation device.

For example, when the navigation device segments the scheduled driving route received from the navigation device of the adjacent vehicle into the plurality of short distance routes of the same distance in step S31, the navigation device may determine whether each of the scheduled driving routes of the plurality of adjacent vehicles is identical with the scheduled driving route of the vehicle including the navigation device, based on each of the plurality of short distance routes of the same distance.

Furthermore, when the navigation device divides and segments the scheduled driving route received from the navigation device of the adjacent vehicle into the plurality of short distance routes based on the spacing between the traffic signals in step S31, the navigation device may determine whether each of the scheduled driving routes of the plurality of adjacent vehicles is identical with the scheduled driving route of the vehicle including the navigation device, based on each of the plurality of short distance routes segmented based on the spacing between the traffic signals.

Next, in step S33, the navigation device may obtain identical path matching percentage information based on the comparing result of the routes in step S32. The identical path matching percentage information may mean the identity percentage between the scheduled driving route of the navigation device using the service of the present disclosure and the scheduled driving route received from the navigation device of the adjacent vehicle.

Specifically, the navigation device may classify the short distance routes into matching and non-matching short distance routes. Then, the navigation device may calculate the identical path matching percentage information based on the plurality of short distance routes obtained in step S31 and a percentage of the matching short distance routes satisfying the route matching condition in step S32 among the plurality of short distance routes.

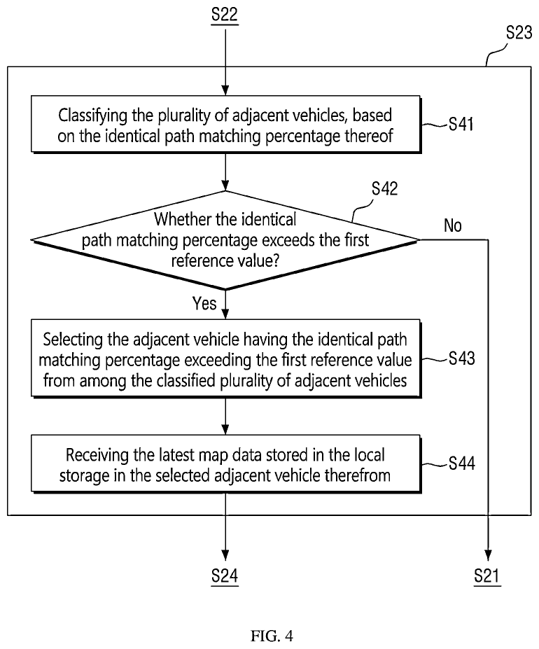

Finally, the navigation device may select one adjacent vehicle among the plurality of adjacent vehicles based on the obtained identical path matching percentage information and receive the latest map data from the navigation device of the selected adjacent vehicle. The specific details related thereto are described in detail in FIG. 4 below.

FIG. 4 is a detailed flowchart showing a process in which the navigation device receives the latest map data.

In step S41, the navigation device may classify the plurality of adjacent vehicles based on the identical path matching percentage of step S33. Specifically, in step S42, the navigation device may classify the plurality of adjacent vehicles based on whether the identical path matching percentage exceeds a first reference value. In this regard, the first reference value is a numerical value that may indicate a requirement to download the latest map data.

For example, in step S42, the first reference value may be 70%. Thus, the latest map data download process according to the present disclosure may not be performed from an adjacent vehicle having the identical path matching percentage is smaller than the first reference value (No in step S42). Then, in step S21, the navigation device may perform a process of re-receiving a scheduled driving route from each of the plurality of adjacent vehicles.

However, in step S42, the latest map data download process according to the present disclosure may be performed from an adjacent vehicle having the identical path matching percentage exceeds the first reference value according to steps S43 and S44 (Yes in step S42).

Specifically, in step S43, the navigation device may select one adjacent vehicle having the identical path matching percentage exceeds the first reference value from among the plurality of adjacent vehicles. In this regard, one adjacent vehicle among the plurality of adjacent vehicles may be selected based on a download time of the latest map data to be received from each navigation device equipped with each of the plurality of adjacent vehicles.

However, the criterion for selecting one adjacent vehicle among a plurality of adjacent vehicles is not limited thereto. The navigation device may select one adjacent vehicle from among the plurality of adjacent vehicles, based on a distance between adjacent vehicles being smaller or the identical path matching percentage being higher.

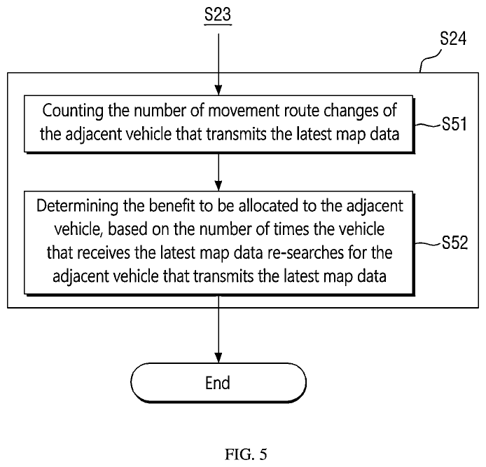

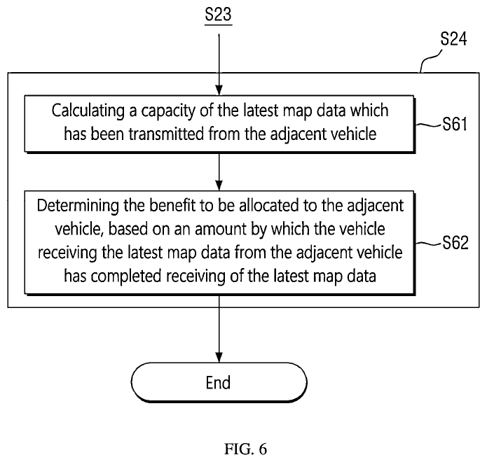

Next, in step S44, the navigation device may receive the latest map data from the navigation device of the adjacent vehicle selected in step S43. According to step S24, the benefit may be provided to the adjacent vehicle that has transmitted the latest map data. The details related to the benefit to be provided to the adjacent vehicle that has transmitted the latest map data are described in detail in FIGS. 5 and 6 below.

FIG. 5 is a detailed flowchart showing a process in which a benefit is determined based on the number of movement route changes.

In step S51, the number of movement route changes of the adjacent vehicle that transmits the latest map data may be counted. In this regard, the number of movement route changes of the adjacent vehicle may be determined based on the number of times the vehicle that receives the latest map data re-searches for the adjacent vehicle that transmits the latest map data.

In the present disclosure, when the adjacent vehicle transmitting the latest map data breaks away from the scheduled driving route during the process of transmitting the latest map data, the process of transmitting the latest map data may be interrupted. Accordingly, a process of re-detecting the adjacent vehicle transmitting the latest map data may be required.

Specifically, the benefit may vary based on the number of movement route changes of the adjacent vehicle transmitting the latest map data. Therefore, in step S52, the benefit provided to the adjacent vehicle may be determined to be variable based on the number of times the vehicle that receives the latest map data re-searches for the adjacent vehicle that transmits the latest map data. The concept of determining the benefit provided to the adjacent vehicle based on the number of times the vehicle that receives the latest map data re-searches for the adjacent vehicle that transmits the latest map data is described in detail in FIG. 10.

FIG. 6 is a detailed flowchart showing a process of determining a benefit based on transmitted capacity of the latest map data.

First, in order to determine the benefit based on the transmitted capacity of the latest map data, the capacity of the latest map data, which has been transmitted from the navigation device of the adjacent vehicle, may be calculated in step S61. In this regard, the capacity of the latest map data, which has been transmitted from the navigation device of the adjacent vehicle, may be determined based on an amount by which the navigation device receiving the latest map data has completed receiving of the latest map data transmitted from the navigation device of the adjacent vehicle.

In step S62, the benefit provided to the adjacent vehicle may be determined to be variable based on the amount by which the latest map data has been received. The concept of determining the benefit based on the amount by which the latest map data has been received is described in detail in FIG. 10.

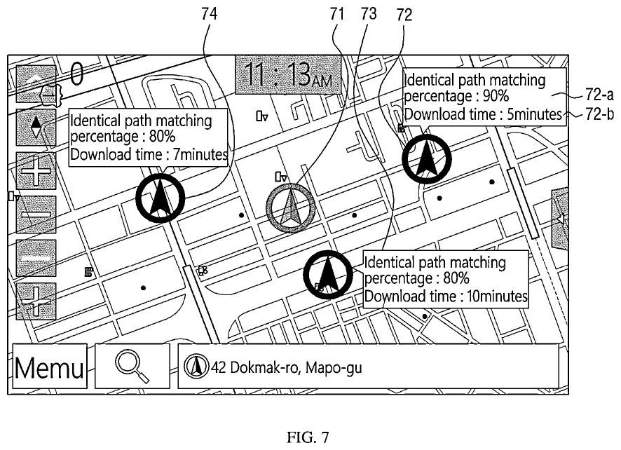

FIG. 7 is an example diagram showing information about adjacent vehicles displayed on a navigation device before receiving the latest map data.

As illustrated in FIG. 7, position coordinate information about the vehicle 71 of the user of the service according to the present disclosure and position coordinate information about adjacent vehicles 72, 73, 74 may be displayed on the screen of the navigation device of the vehicle 71. Furthermore, information about each of the adjacent vehicles 72, 73, 74 including the identical path matching percentage information 72-a and download time information 72-b thereof may be displayed on the screen of the navigation device of the vehicle 71.

In this regard, the download time information may mean estimated download completion time information about each of the scheduled driving routes based on the plurality of latest map data respectively stored in the navigation devices of the adjacent vehicles.

A user of the service according to the present disclosure may select one of the adjacent vehicles 72, 73, 74 based on the identical path matching percentage information 72-a and the download time information 72-b about each of the adjacent vehicles 72, 73, 74.

Alternatively, the user of the service according to the present disclosure may select one of the scheduled driving routes respectively provided from the plurality of adjacent vehicles 72, 73, 74 based on the identical path matching percentage information 72-a and the download time information 72-b about each of the adjacent vehicles 72, 73, 74.

However, for the convenience of description, the description is made below under assuming that the adjacent vehicle 72 is selected by the user.

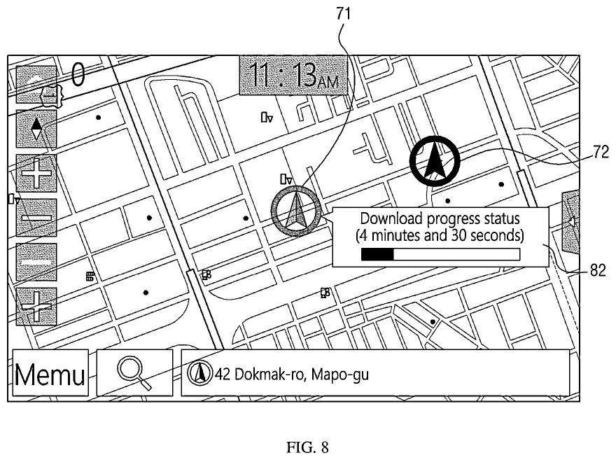

FIG. 8 is an example of information about the adjacent vehicle being displayed on the navigation device during the process of receiving the latest map data.

As shown in FIG. 8, position coordinate information about the vehicle 71 of the user of the service according to the present disclosure and position coordinate information about the adjacent vehicle selected by the navigation service user may be displayed on the navigation device of the vehicle 71. Furthermore, real-time download information 82 of the latest map data transmitted from the navigation device disposed in the adjacent vehicle selected by the user may be displayed on the screen of the navigation device of the vehicle 71.

In this regard, the real-time download information may include information about a remaining time until the downloading of the latest map data has been completed. A ratio of the remaining time information to total download time information may be displayed.

Accordingly, the service user of the present disclosure may clearly know a state in which the downloading is currently in progress and may roughly predict a time at which the downloading of the latest map data is finally completed.

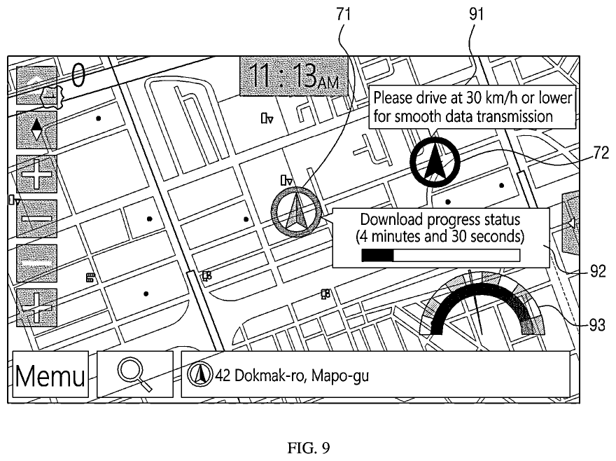

FIG. 9 is an example diagram of a state in which download progress status information is displayed on a navigation device disposed in an adjacent vehicle transmitting the latest map data.

As shown in FIG. 9, position coordinate information about the vehicle 71 of the user of the service according to the present disclosure and position coordinate information about the adjacent vehicle 72 transmitting the latest map data may be displayed on the navigation device of the vehicle 72.

Furthermore, real-time download information 92 of the latest map data transmitted from the navigation device disposed in the adjacent vehicle selected by the user may be displayed on the screen of the navigation device of the vehicle 72. Therefore, the real-time download information 92 of the latest map data may be displayed on the screens of both the navigation device transmitting the latest map data and the navigation device receiving the latest map data.

In this regard, the real-time download information 92 may include remaining time information until the downloading of the latest map data has been completed. The ratio of the remaining time information to the total download time information may be displayed.

Next, the navigation device disposed in the adjacent vehicle transmitting the latest map data may display an auxiliary UI 91 indicating speed information of the vehicle transmitting the map data. In this regard, the vehicle's speed information may mean speed information at which the adjacent vehicle transmitting the latest map data should drive in order to maintain short-range communication with the adjacent vehicle 71 thereto receiving the latest map data.

For example, the auxiliary UI 91 indicating the vehicle's speed information may display a text, ‘Please drive at 30 km/h or lower for smooth data transmission.’ In this regard, ‘30 km/h or lower’ corresponding to the vehicle's speed information is only an example, and the speed information may include all speed values at which the adjacent vehicle transmitting the latest map data should drive in order to maintain short-range communication with the adjacent vehicle 71 thereto receiving the latest map data.

In this way, the auxiliary UI 91 may assist the driver to maintain a constant speed of the vehicle.

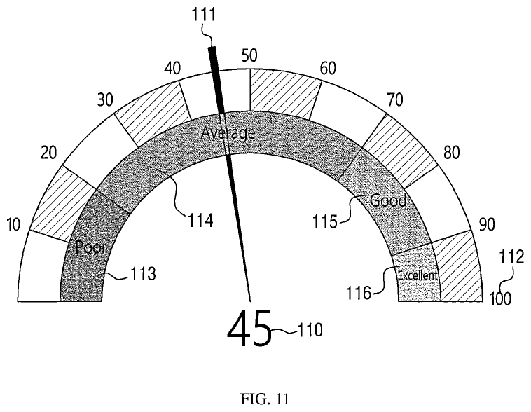

Next, benefit information 93 generated based on the transmission of the latest map data may be displayed on the navigation device disposed in the adjacent vehicle transmitting the latest map data. The specific details related thereto are described in detail in FIG. 10 and FIG. 11 below.

FIG. 10 is an example diagram showing benefit information generated based on a route keeping condition and a data reception condition.

First, according to the present disclosure, the benefit provided to the vehicle having transmitted the latest map data may be determined to be variable depending on the route keeping condition 101 or the data reception condition 102. However, this is only an example, and the benefit may be determined in consideration of both the route keeping condition 101 and the data reception condition 102.

First, the route keeping condition 101 may be a condition for determining whether the vehicle transmitting the latest map data continuously maintains the scheduled driving route. Then, a benefit 101-b determined using the route keeping condition 101 of the vehicle transmitting the latest map data may be determined based on whether the vehicle receiving the latest map data performs route breakaway-caused re-search 101-a.

For example, when the vehicle receiving the latest map data performs the route breakaway-caused re-search 101-a a single time due to a breakaway from the scheduled driving route of the vehicle transmitting the latest map data, 90 points of the benefit 101-b may be provided to the vehicle that transmits the latest map data.

Similarly, when the vehicle receiving the latest map data performs the route breakaway-caused re-search 101-a twice due to the breakaway from the scheduled driving route of the vehicle transmitting the latest map data, 80 points of the benefit 101-b may be provided to the vehicle that transmits the latest map data.

However, when the vehicle receiving the latest map data cannot perform the route breakaway-caused re-search 101-a due to the breakaway from the scheduled driving route of the vehicle transmitting the latest map data, zero point of the benefit 101-b may be provided to the vehicle that transmits the latest map data.

In this way, the benefit 101-b may be provided to the vehicle that transmits the latest map data, based on the number times the vehicle receiving the latest map data performs the route breakaway-caused re-search 101-a. In this regard, the number times the vehicle receiving the latest map data performs the route breakaway-caused re-search 101-a, and the benefit 101-b provided to the vehicle having transmitted the latest map data based on the number times the vehicle receiving the latest map data performs the route breakaway-caused re-search 101-a may be different from those shown in FIG. 9.

Next, the data reception condition 102 may be a condition for quantitatively determining a reception completion percentage of the latest map data based on the vehicle receiving the latest map data. Then, the benefit 102-b provided to the vehicle having transmitted the latest map data may be determined based on a data reception completion percentage 102-a of the vehicle receiving the latest map data.

For example, when an entirety of the latest map data which has been transmitted from the vehicle having transmitted the latest map data has been received 102-a by the vehicle receiving the latest map data, 100 points of the benefit 102-b may be provided to the vehicle that transmits the latest map data.

Similarly, when 80% exclusive to 100% exclusive of the latest map data transmitted from the vehicle having transmitted the latest map data has been received by the vehicle receiving the latest map data, 80 points of the benefit 102-b may be provided to the vehicle that transmits the latest map data.

However, when the vehicle receiving the latest map data does not receive any portion of the latest map data due to the breakaway from the scheduled driving route of the vehicle transmitting the latest map data, zero point of the benefit 102-b may be provided to the vehicle that transmits the latest map data.

In this way, the benefit 102-b may be provided to the vehicle that transmits the latest map data, based on the reception completion percentage 102-a of the latest map data of the vehicle receiving the latest map data. In this regard, the reception completion percentage 102-a of the latest map data and the benefit 102-b provided to the vehicle having transmitted the latest map data based on the reception completion percentage may be different from those illustrated in FIG. 9.

FIG. 11 is an example of benefit information displayed on a navigation device transmitting the latest map data.

First, the benefit information displayed on the navigation device may include an acquired benefit 110, benefit grades 113, 114, 115, 116, a benefit indicator 111 indicating the acquired benefit, and a benefit numeric value 112. In this regard, the acquired benefit 110 may mean benefit information currently acquired by the vehicle equipped with the navigation device transmitting the latest map data.

Then, the benefit grades 113, 114, 115, 116 may include ‘Poor’ grade, ‘Average’ grade, ‘Good’ grade, and ‘Excellent’ grade. For example, when the benefit value obtained by the vehicle having transmitted the latest map data is within a range of 0 to 20, the benefit grade 113 may be ‘Poor’ grade. When the benefit value obtained by the vehicle having transmitted the latest map data is within a range of 20 to 70, the benefit grade 114 may be ‘Average’ grade.

Furthermore, when the benefit value obtained by the vehicle having transmitted the latest map data is within a range of 70 to 90, the benefit grade 115 may be ‘Good’ grade. Further, when the benefit value obtained by the vehicle having transmitted the latest map data is within a range of 90 to 100, the benefit grade 116 may be ‘Excellent’ grade.

However, each of the benefit grades 113, 114, 115, 116 and the benefit numerical range corresponding to each benefit grade are only examples.

Next, the benefit numerical value 112 indicates the range of the benefit grades 113, 114, 115, 116 and may be expressed as a numerical value obtained by further subdividing the benefit grades 113, 114, 115, 116.

Finally, the benefit indicator 111 indicating the acquired benefit may indicate either the benefit grade 113, 114, 115, 116 or the benefit numerical value 112. Accordingly, the user using the navigation service may check the current grade corresponding to the currently acquired benefit and may predict a future grade based on the current grade.

Again, referring to the example diagram illustrated in FIG. 11, the acquired benefit 110, the benefit grades 113, 114, 115, 116, the benefit indicator 111 indicating the acquired benefit, and the benefit numerical value 112 may be displayed on the navigation device transmitting the latest map data.

For example, the current acquired benefit 110 may be displayed as a number 45. The benefit indicator 111 indicating the benefit number 112 in a range between 40 and 50 and the ‘Average’ grade 114 may be displayed on the navigation device.

Accordingly, the user using the navigation service may identify that the current acquired benefit is positioned at the ‘Average’ grade and then may expect that he or she will be positioned at the ‘Good’ grade if he or she further acquires 25 benefits in the future.

Accordingly, the owner of the vehicle transmitting the latest map data may transmit a larger amount of the latest map data to an adjacent vehicle.

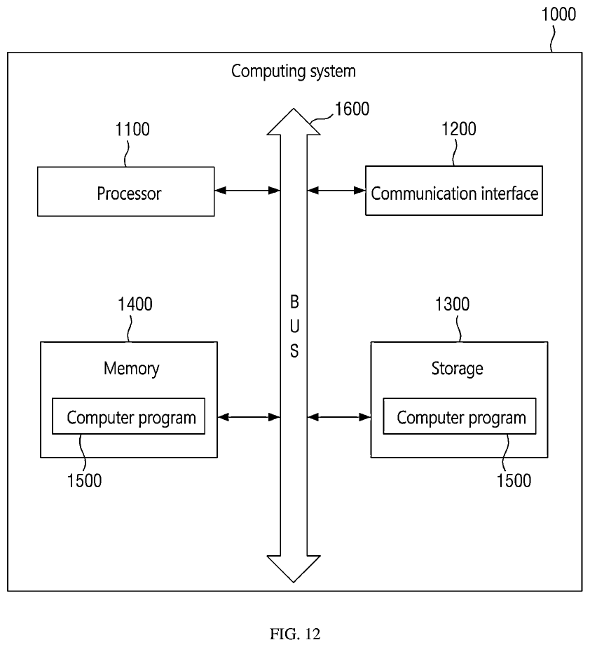

The method for downloading the latest map according to an embodiment of the present disclosure has been described above with reference to FIG. 1-FIG. 11. Hereinafter, a hardware configuration of the latest map download system is described with reference to FIG. 12.

FIG. 12 is an example hardware configuration diagram of a computing system 1000 according to an embodiment of the present disclosure. The computing system 1000 corresponds to the latest map download system 10 as described above.

As shown in FIG. 12, the computing system 1000 may include one or more processors 1100, a bus 1600, a communication interface 1200, a memory 1400 that loads thereon a computer program executed by the processor 1100, and a storage 1300 that stores therein a computer program 1500.

However, FIG. 12 only shows the components related to the embodiment of the present disclosure. Therefore, a person having ordinary skill in the art to which the present disclosure belongs may know that other general components may be included in addition to the components shown in FIG. 12. In other words, the computing system 1000 may include various components in addition to the components shown in FIG. 12. Furthermore, in some cases, the computing system 1000 may be configured in a structure in which some of the components shown in FIG. 12 is omitted. Hereinafter, each of the components of the computing system 1000 is described.

The processor 1100 may control all operations of the components of the computing system 1000. The processor 1100 may be configured to include at least one of a CPU (Central Processing Unit), an MPU (Micro Processor Unit), an MCU (Micro Controller Unit), a GPU (Graphics Processing Unit), or any further type of a processor well known in the technical field of the present disclosure. Furthermore, the processor 1100 may perform computations of at least one application or program for executing operations/methods according to an embodiment of the present disclosure. The computing system 1000 may have one or more processors.

Next, the memory 1400 may store therein various data, commands, and/or information. The memory 1400 may load therein the computer program 1500 from the storage 1300 to execute operations/methods according to an embodiment of the present disclosure. The memory 1400 may be embodied as a volatile memory such as RAM. However, the present disclosure is not limited thereto.

Next, the bus 160 may provide a communication function between the components of the computing system 1000. The bus 1600 may be embodied as various types of buses such as an address bus, a data bus, and a control bus.

Next, the communication interface 1200 may support wired and wireless Internet communication of the computing system 1000. Furthermore, the communication interface 540 may support various communication schemes other than Internet communication. To this end, the communication interface 1200 may be configured to include a communication module well known in the technical field of the present disclosure.

Next, the storage 1300 may non-temporarily store therein one or more computer programs 1500. The storage 1300 may be configured to include a non-volatile memory such as Read Only Memory (ROM), Erasable Programmable ROM (EPROM), Electrically Erasable Programmable ROM (EEPROM), flash memory, a hard disk, a removable disk, or any form of computer-readable recording medium well known in the art to which the present disclosure belongs.

Next, the computer program 1500 may include one or more instructions that cause the processor 1100 to perform the operations/methods according to various embodiments of the present disclosure when being loaded into the memory 1400. That is, the processor 1100 may execute one or more loaded instructions to perform the operations/methods according to various embodiments of the present disclosure.

For example, the computer program 1500 may include instructions for receiving a scheduled driving route stored in a local storage within each of a plurality of adjacent vehicles from each of the plurality of adjacent vehicles. The plurality of adjacent vehicles is adjacent to the vehicle having the navigation device. The computer program 1500 may also include instructions for obtaining identical path matching percentage information about each of the plurality of adjacent vehicles based on the scheduled driving route thereof. The computer program 1500 may also include instructions for receiving the latest map data stored in the local storage within the adjacent vehicle having the identical path matching percentage exceeding a first reference value. The computer program 1500 may also include instructions for providing a benefit to the adjacent vehicle that transmits the latest map data.

Although some embodiments of the present disclosure have been described above with reference to the accompanying drawings, the present disclosure may not be limited to some embodiments and may be implemented in various different forms. Those of ordinary skill in the art to which the present disclosure belongs should be able to appreciate that the present disclosure may be implemented in other specific forms without changing the technical idea or essential features of the present disclosure. Therefore, it should be understood that some embodiments as described above are not restrictive but illustrative in all respects.

A variety of embodiments of the present disclosure and the effects according to embodiments thereof have been mentioned with reference to FIGS. 1-12. The effects according to the technical idea of the present disclosure are not limited to the forementioned effects, and other unmentioned effects may be clearly understood by those having ordinary skill in the art from the description of the specification.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those having ordinary skill in the art should appreciate that many variations and modifications can be made to the embodiments without substantially departing from the principles of the present disclosure. Therefore, the disclosed embodiments of the disclosure are used in a generic and descriptive sense only and not for purposes of limitation.

What is claimed is:

1. A method for downloading latest map data, the method being performed by a navigation device of a vehicle, the method comprising:
receiving a scheduled driving route stored in a local storage within each of a plurality of adjacent vehicles from each of the plurality of adjacent vehicles, wherein the plurality of adjacent vehicles is adjacent to the vehicle having the navigation device;
obtaining identical path matching percentage information about each of the plurality of adjacent vehicles based on the scheduled driving route;
receiving the latest map data stored in the local storage within an adjacent vehicle having the identical path matching percentage exceeding a first reference value; and
providing a benefit to an adjacent vehicle that transmits the latest map data.

2. The method of claim 1, wherein the plurality of adjacent vehicles includes a plurality of adjacent vehicles configured to be connected to the vehicle having the navigation device via short-range communication.

3. The method of claim 1, wherein receiving the scheduled driving route from each of the plurality of adjacent vehicles includes:
connecting to each of the plurality of adjacent vehicles via short-range communication; and
receiving the scheduled driving route based on a final destination of each of the plurality of adjacent vehicles connected to the vehicle via the short-range communication,
wherein the final destination of each of the plurality of adjacent vehicles is close to a final destination of the vehicle having the navigation device.

4. The method of claim 1, wherein obtaining the identical path matching percentage information about each of the plurality of adjacent vehicles includes:
segmenting the scheduled driving route received from each of the plurality of adjacent vehicles into a plurality of short distance routes;
determining whether each of the scheduled driving route of each of the plurality of adjacent vehicles is identical with a scheduled driving route of the vehicle having the navigation device, based on the plurality of short distance routes; and
obtaining the identical path matching percentage information of each of the plurality of adjacent vehicles, based on a determination result.

5. The method of claim 4, wherein lengths of the plurality of short distance routes obtained by segmenting the scheduled driving route are equal to each other.

6. The method of claim 4, further comprising:
obtaining the plurality of short distance routes by segmenting the scheduled driving route based on spacings between adjacent traffic signals arranged in the scheduled driving route.

7. The method of claim 4, wherein determining whether each of the scheduled driving route of each of the plurality of adjacent vehicles is identical with the scheduled driving route of the vehicle having the navigation device, based on the plurality of short distance routes includes:
determining whether each of the short distance routes of the scheduled driving route of each of the plurality of adjacent vehicles is identical with each of segmented short distance routes of the scheduled driving route of the vehicle having the navigation device.

8. The method of claim 4, wherein determining whether each of the scheduled driving route of each of the plurality of adjacent vehicles is identical with the scheduled driving route of the vehicle having the navigation device, based on the plurality of short distance routes includes:
determining whether each of the short distance routes of the scheduled driving route of each of the plurality of adjacent vehicles is identical with each of segmented short distance routes of the scheduled driving route of the vehicle having the navigation device,
wherein obtaining the identical path matching percentage information of each of the plurality of adjacent vehicles, based on the determination result includes:
classifying each of the segmented short distance routes of the scheduled driving route of each of the plurality of adjacent vehicles into matching and non-matching short distance routes with the segmented short distance routes of the scheduled driving route of the vehicle having the navigation device; and
calculating the identical path matching percentage information based on a percentage of the matching short distance routes among the plurality of short distance routes.

9. The method of claim 1, wherein receiving the latest map data stored in the local storage within the adjacent vehicle having the identical path matching percentage exceeding the first reference value includes:
classifying the plurality of adjacent vehicles, based on the identical path matching percentage;
selecting the adjacent vehicle having the identical path matching percentage exceeding the first reference value from among the classified plurality of adjacent vehicles; and
receiving the latest map data stored in the local storage in the selected adjacent vehicle from the selected adjacent vehicle.

10. The method of claim 9, wherein selecting the adjacent vehicle having the identical path matching percentage exceeding the first reference value from among the classified plurality of adjacent vehicles includes:
when there is a plurality of adjacent vehicles respectively having the identical path matching percentages exceeding the first reference value, selecting one adjacent vehicle from the plurality of adjacent vehicles respectively having the identical path matching percentages exceeding the first reference value.

11. The method of claim 10, wherein selecting the one adjacent vehicle includes selecting one adjacent vehicle having a highest identical path matching percentage among the plurality of adjacent vehicles having the identical path matching percentages exceeding the first reference value.

12. The method of claim 10, wherein selecting the one adjacent vehicle includes selecting one adjacent vehicle, based on a download time of the latest map data from each of the plurality of adjacent vehicles.

13. The method of claim 1, wherein providing the benefit to the adjacent vehicle that transmits the latest map data includes determining the benefit to be provided to the adjacent vehicle, based on a number of movement route changes of the adjacent vehicle that transmits the latest map data.

14. The method of claim 13, further comprising:
determining the number of movement route changes of the adjacent vehicle based on a number of times the vehicle receiving latest map data re-searches for the adjacent vehicle transmitting the latest map data.

15. The method of claim 1, wherein providing the benefit to the adjacent vehicle that transmits the latest map data includes determining a benefit to be provided to the adjacent vehicle, based on a capacity of the latest map data having been transmitted from the adjacent vehicle.

16. The method of claim 15, further comprising:
determining the capacity of the latest map data having been transmitted from the adjacent vehicle based on an amount of the latest map data having been received by the vehicle from the adjacent vehicle.

17. A navigation device for transmitting latest map data, comprising a processor configured to:
transmit a scheduled driving route stored in a local storage of the navigation device to a navigation device of an adjacent vehicle, wherein the adjacent vehicle is adjacent to a vehicle including the navigation device for transmitting the latest map data;
receive a request of transmitting the latest map data based on the scheduled driving route from the navigation device of the adjacent vehicle; and
display real-time download information of the latest map data in response to receiving the request of transmitting the latest map data.

18. The navigation device of claim 17, wherein the processor is further configured to display an auxiliary UI indicating speed information of the vehicle including the navigation device for transmitting the latest map data.

19. A navigation device for receiving latest map data, comprising a processor configured to:
receive a scheduled driving route from a navigation device included in each of a plurality of adjacent vehicles, wherein the plurality of adjacent vehicles is adjacent to a vehicle including the navigation device for receiving the latest map data;
determine identical path matching percentage information about each of the scheduled driving routes; and
display a download expected time information about each of the scheduled driving routes, based on each of the scheduled driving routes and the latest map data stored in each of the plurality of navigation devices.

20. The navigation device of claim 19, wherein the processor is further configured to:
select one of the received scheduled driving routes based on a user input; and
display real-time download information of the selected scheduled driving route.
